(19) United States
(12) Patent Application Publication
(10) Pub. No.: US 2004/0001721 A1
(43) Pub. Date: Jan. 1, 2004

(54) Methods and apparatus for monitoring optical transmissions

(75) Inventors: Clyde George Bethea, Franklin Park, NJ (US); John Philip Franey, Bridgewater, NJ (US); Jorge Luis Valdes, Branchburg, NJ (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ (US)

(21) Appl. No.: 10/180,173

(22) Filed: Jun. 26, 2002

(51) Int. Cl. H04B 10/04

(52) U.S. Cl. 398/197

(57) ABSTRACT

Techniques for monitoring optical transmissions between an optical transmitter and an optical receiver are described. A transmitter monitor is coupled to an optical transmitter and detects light, such as reflected light, conducted into the transmitter by an optical cable conveying light between the transmitter and the receiver. The transmitter monitor produces a signal providing information about the light conducted into the transmitter and adjustments are made to the transmitter operation based on the signal. A receiver monitor coupled to an optical receiver detects light conducted into the receiver by the optical cable. The receiver monitor produces a receiver monitor signal providing information about the light and adjustments are made to the receiver operation based on the signal. In addition, an optical signal is sent to the transmitter based on the receiver monitor signal, and the optical signal is used by the transmitter monitor to direct adjustments to the transmitter operation.

### FIELD OF THE INVENTION

The present invention relates generally to optical signal transmission and reception. More particularly, the invention relates to advantageous techniques for sensing characteristics of an optical signal transmitted from an optical transmitter to an optical receiver along an optical cable and adjusting the transmitter if the characteristics of the optical signal indicate the presence of undesirable conditions.

### BACKGROUND OF THE INVENTION

Optical transmission systems are widely used for the fast and efficient transmission of large amounts of data. A typical optical transmission system includes one or more transmitter-receiver pairs. Each transmitter-receiver pair may include a transmitter station connected to a receiver station by an optical cable comprising one or more optical fibers. The transmitter produces an optical signal, suitably by using a high powered laser to produce the signal. The optical signal is transmitted to the receiver over the optical cable. An optical transmission system may include a series of transmitter-receiver pairs connected in series in order to transmit signals over a very long distance. A single transmitter-receiver pair in a series may be connected by an optical cable on the order of several kilometers long and a series of transmitter-receiver pairs with accompanying optical cables may be on the order of hundreds or thousands of kilometers long.

Typically, during at least some phases of operation, the signal generated by the transmitter for transmission to the receiver has substantial power. It is necessary for such a signal to be conducted and received correctly to prevent the risk of damage to the transmitter, the receiver or the optical cable.

Further, numerous conditions may occur which will interfere with the proper transmission of the signal. These include, for example, contamination of the optical cable or misalignment, disconnection or breakage of the optical cable. These and other conditions can cause improper dissipation of optical power by the transmitter. This improper dissipation of power may take the form of overheating and can quickly lead to serious damage to the transmitter or the optical interface. Failure to detect conditions leading to improper dissipation of optical power and to adjust the transmitter accordingly may lead to substantial damage to the transmitter or to the optical cable, causing great expense for repair.

In addition, the optical signal transmitted from the transmitter to the receiver can be used to obtain information indicating the condition of the transmission and the connection. Sensing of the optical signal and analysis of the optical signal to identify the indicated conditions would, in many cases, provide information about the condition of the optical cable, the status and operation of the transmitter or other conditions. In some cases, conditions may be detected at the receiver that indicate problems at the transmitter. Rapid communication with and adjustment of the transmitter upon detection of these conditions could prevent serious damage to one or more of the transmitter, the optical cable, or the receiver.

There exists, therefore, a need for improved techniques for sensing the optical signal conducted between an optical transmitter and an optical receiver, analyzing the optical signal to determine the optical power dissipated by the optical signal, controlling the transmitter and receiver based on conditions indicated by analysis of the transmitter signal, and providing high speed communication between the receiver and the transmitter to control the transmitter based on conditions detected at the receiver.

### SUMMARY OF THE INVENTION

A transmitter monitor according to an aspect of the present invention is adapted for use with an optical transmitter. The optical transmitter may suitably be connected to an optical receiver using an optical cable. The optical transmitter may be connected to the optical cable by a connector having an interlock feature, so that disengaging the connector provides a signal directing shutoff of the transmitter.

The transmitter monitor senses a return signal comprising optical signals and reflected or otherwise residual light conducted back into the optical transmitter from the optical cable. Typically, any optical signal propagated from an optical transmitter to an optical receiver is subject to insertion losses comprising dissipation loss and reflection loss. Dissipation losses occur due to the conversion of a portion of the optical signal to heat, and reflection losses occur due to a reflection of a portion of the optical signal back along the optical cable from the destination to the source. The reflection loss results in conduction of a portion of the optical signal back to the optical transmitter. The reflection loss typically provides an indication of the optical power dissipation of the optical signal, and a change in the reflection loss typically indicates a change in the dissipation of optical power and can be sensed or otherwise evaluated in order to determine the nature and extent of the change in the dissipation of optical power. In addition, or alternatively, components of the receiver may transmit their own receiver signal, used to communicate with the transmitter and conducted into the optical cable for detection by the transmitter monitor.

The conduction to the transmitter of reflected or residual light, optical signals or the like typically occurs when the amplifier is providing an optical signal to the receiver. When the transmitter is transmitting the signal and the optical connection is normal, a predictable level of reflection typically results. The level of reflection can be predicted by taking into account the optical power generated or expected to be generated by the transmitter, the optical characteristics of the optical cable and other relevant factors. If the level of reflected light deviates from that predicted for normal operation, the nature and extent of the deviation can be interpreted in order to determine if it indicates that the optical connection has become damaged or contaminated or if a condition, such as excessive or otherwise improper dissipation of optical power, exists indicating that the transmission should be stopped or altered. In addition, the receiver may be designed to transmit its own signal into the optical cable in order to provide information about the optical signal detected at the receiver.

The transmitter monitor examines the characteristics of the light conducted back into the transmitter and takes appropriate action. For example, if the transmitter monitor detects an increase in the light coming into the transmitter, this may indicate an increase in reflected light and an accompanying decrease in the power of the transmitter signal reaching the receiver. This reflection may result from contamination of the optical cable and a resulting loss of signal that should have been conducted to the receiver and a conversion into heat of the power used to create the signal. Contamination of the optical cable may thus create a danger of overheating. In such a case, the transmitter monitor may shut off the transmitter and sound an alarm. As another example, the receiver may be designed to transmit light back to the transmitter in order to provide information about the operation of the receiver. For example, during normal operation, the receiver may transmit its own diagnostic optical signal back to the transmitter, with the optical signal having a wavelength different from that produced by the transmitter being sent to the transmitter in order to provide diagnostic information about the signal being received from the transmitter and the operation of the receiver. Sensing of this diagnostic signal may indicate to the transmitter monitor that the receiver is operating normally, and failure to sense the diagnostic signal may indicate that the receiver is not operating correctly. Alternatively, the receiver may be able to choose or vary the diagnostic signal to send desired information to the receiver, and the transmitter monitor may sense the characteristics of the diagnostic signal and react accordingly.

As noted above, the transmitter is typically connected to a receiver by an optical cable. A receiver monitor according to the present invention is preferably connected to the receiver in such a way that the receiver monitor can sense the optical signal propagated from the transmitter to the receiver along the optical cable. The receiver may suitably be connected to the optical cable by a receiver connector similar to the transmitter connector referred to above. The receiver connector directs shutoff of the receiver when the receiver connector is disengaged, and also stops operation of the receiver monitor. As will be seen below, stopping operation of the receiver monitor may provide an indication of an abnormal condition of the transmitter.

The receiver monitor is preferably electrically connected to the receiver connector, and under some circumstances may be connected to a control module that communicates electrically with the transmitter. Typically, the receiver monitor communicates with the transmitter monitor by sending a receiver monitor signal through the optical cable so that the receiver signal may be sensed by the transmitter monitor as a component of the return signal. If the transmitter signal detected at the receiver does not fall within predefined parameters, the receiver monitor may signal the receiver connector to disconnect the receiver from the optical cable, and may also transmit a receiver monitor signal into the cable in order to communicate with the transmitter monitor. For example, the receiver monitor may simply transmit a relatively high power receiver monitor signal that will be interpreted by the transmitter monitor as reflected light indicating an increase in reflection losses and will cause the transmitter monitor to sense that improper dissipation of optical power is occurring and to turn off the transmitter in order to stop the improper dissipation of optical power. To take another example, during normal operation the receiver monitor may transmit a relatively low power receiver monitor signal having a specially chosen wavelength. As noted above, the transmitter monitor may be designed to interpret this receiver monitor signal as indicating normal operation and to interpret the absence of such a receiver monitor signal as indicating abnormal operation. Shutoff of the receiver monitor, such as may be caused by disconnection of the receiver connector, may stop transmission of this receiver monitor signal and thereby cause the transmitter monitor to generate an indication that the transmitter is operating abnormally.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a transmitter-receiver pair employing a monitoring system according to the present invention;

FIG. 2 illustrates a transmitter according to the present invention;

FIG. 3 illustrates a receiver according to the present invention;

FIG. 4 illustrates an alternative receiver according to the present invention; and

FIG. 5 illustrates a process of optical transmission utilizing transmitter and receiver monitoring according to the present invention.

### DETAILED DESCRIPTION

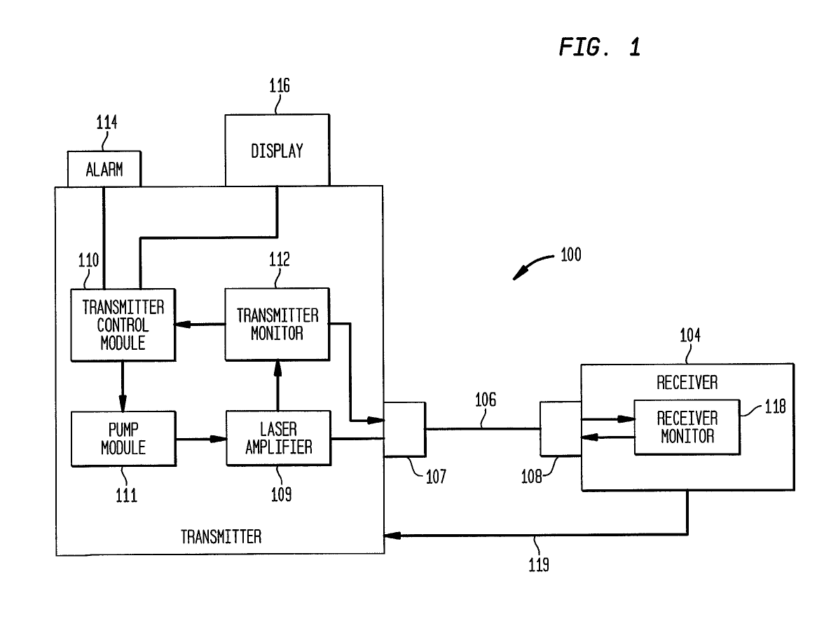

FIG. 1 illustrates a transmitter-receiver pair 100 employing a monitoring system according to the present invention. The transmitter-receiver pair 100 includes a transmitter 102, a receiver 104 and an optical cable 106 for conveying an optical signal or other output from the transmitter 102 to the receiver 104. The transmitter 102 may suitably include a transmitter connector 107, which can be used to connect or disconnect the transmitter 102 and the optical cable 106. The receiver 104 may include a receiver connector 108, which effectively connects or disconnects the receiver 104 and the optical cable 106. The connectors 107 and 108 may suitably include interlocks indicating when they are disengaged.

The transmitter 102 includes a laser amplifier 109, for producing an amplified optical signal to be conducted to the receiver 104 by the optical cable 106. The transmitter 102 also includes a transmitter control module 110. The transmitter control module 110 controls a pump module 111, which effectively turns on and shuts off the laser amplifier 109, and thus the transmitter 102, by turning a pumping current on or off.

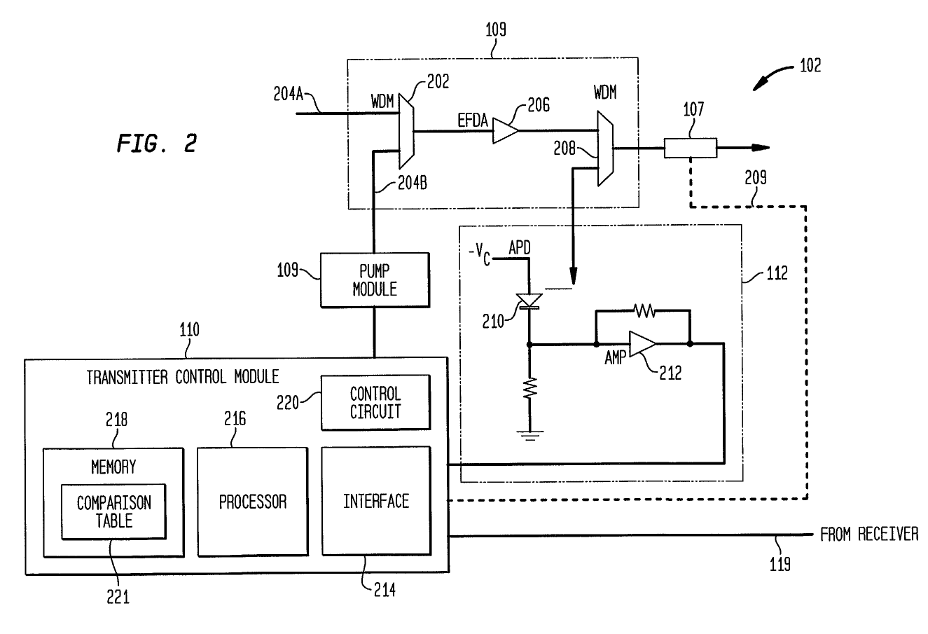

The transmitter 102 also includes a transmitter monitor 112, which senses optical signals and other light, such as reflected or residual light, being conducted into the transmitter 102 by the optical cable 106. This light may suitably enter the laser amplifier 109, and the transmitter monitor 112 may suitably be connected to the laser amplifier in such a way that a portion of the light entering the laser amplifier 109 from the optical cable 106 enters the transmitter monitor 112. Additional details of the design of the transmitter monitor 112 and its connection to the laser amplifier 109 are shown in FIG. 2 and discussed below.

The transmitter monitor 112 produces a signal that can be used by the transmitter control module 110 to indicate the quality of the optical connection between the transmitter 102 and the receiver 104. The quality of the connection includes such factors as the power, coherence, reflection losses, dissipation losses and other characteristics of the transmitter signal transmitted along the optical cable 106, and whether these characteristics meet predetermined criteria chosen to define a normal operation. If the quality of the connection is not acceptable, for example if the reflection losses are too low or too high, the transmitter control module 110 may take appropriate action, for example, stopping operation of the transmitter 102, adjusting the power of the signal being transmitted, or alerting an operator using an alarm 114, a display 116, or another suitable method of communication.

The receiver 104 includes a receiver monitor 118, which monitors the transmitter signal received from the optical cable and senses characteristics of the transmitter signal. In some transmitter-receiver pair designs, an electrical connection 119 may be available for sending an electrical signal from the receiver 104 to the transmitter control module 110. In such a case, the receiver monitor 118 may be able to send an electrical signal directing the transmitter control module 110 to turn off the pump module 111.

The receiver monitor 118 is also capable of transmitting its own receiver signal back into the optical cable 106. This receiver signal comprises part of the return signal received and interpreted by the transmitter monitor 112, and can be used by the transmitter monitor 112 to provide information to the transmitter control module. The receiver signal may add a component to the return signal that is sensed by the transmitter monitor 112, causing the transmitter monitor signal, to have characteristics interpreted by the transmitter control module 110 as an indication that an undesirable condition is present. Depending on the specific indication, the transmitter control module 110 may, for example, shut off the pump module 111, adjust power being provided to the pump module 111 in order to adjust the power or other properties of the transmitter signal or use the alarm 114 or the display 116 to provide appropriate information to an operator.

It will be recognized that two-way optical communication is possible using an optical cable such as the cable 106. In one exemplary case, an assembly (not shown) could be constructed including an optical cable similar to that of the cable 106 having at each end a combined transmitter-receiver having a transmitter portion including elements similar to those of the transmitter 102 and a receiver portion similar to those of the receiver 104. Communication might suitably be achieved by using one wavelength for transmission in one direction and a different wavelength for transmission in the other direction. Such an assembly might suitably include a transmitter monitor such as the transmitter monitor 112 at each transmitter portion and a receiver monitor such as the receiver monitor 118 at each receiver portion.

FIG. 2 illustrates additional details of the transmitter 102, including details of the transmitter monitor 112. The laser amplifier 109 includes a first wave division multiplexer (WDM) 202. The first WDM 202 includes an information signal input 204A, for receiving a signal, or seed beam, suitably produced by an optical communication device (not shown) that is producing the signal to be amplified and transmitted by the transmitter 102. The first WDM 202 also includes an amplification input 204B. The amplification input 204B receives an amplification signal, or pump beam, from the pump module 111, controlled by the transmitter control module 110. The first WDM 202 combines the information signal with the amplification signal to produce a transmission signal. The transmission signal is passed to an erbium doped fiber amplifier (EDFA) 206, which may suitably act as a Raman amplifier. The EFDA 206 depletes the amplification signal and amplifies the information signal, to produces an amplified signal which is then passed to a second WDM 208, which produces the transmitter signal. The transmitter signal is transmitted to the receiver 104 using the optical cable 106. The transmitter 102 may suitably include the transmitter connector 107, which is preferably capable of sensing misalignments or other connection problems, and is also preferably capable of signaling the transmitter control module 110 in order to adjust or shut off the pump module 111, using the electrical connection 209.

In addition, the transmitter 102 is capable using the transmitter monitor 112 to sense the characteristics of a return signal comprising optical signals or reflected or residual light passing back into the transmitter through the optical cable 106. Detection of certain predetermined properties of the return signal may indicate difficulties with the connection or may indicate signals being passed to the transmitter 102 by the receiver 108, in order to control the transmitter 102.

Typically, by far the bulk of the transmitter signal passes to the receiver 104 through the optical cable 106. A portion of this signal, however, usually on the order of 1% or less of the original transmitter signal, is reflected back to the WDM 208 from the optical cable 106 as all or part of the return signal, and examination of this component of the return signal can provide valuable information about the condition of the optical cable 106, and the quality of the connection between the transmitter 102 and the receiver 104.

In order to take advantage of the information provided by the return signal, the transmitter monitor 112 is connected to the second WDM 208 to sense the quantity and characteristics of light reflected back to the WDM 208, or otherwise conducted to the WDM 208 by the optical cable 106. The quality or level of the return signal can indicate the condition of the optical cable 106. For example, the component of the return signal due to reflection of the transmitter signal may provide information about whether the optical cable 106 is transmitting light properly or whether it is disconnected, broken or contaminated by dirt or other materials. Failure to detect a condition that interferes with the ability of the optical cable 106 to conduct light properly can lead to overloading of the transmitter 102 or the optical cable 106 by overheating or other overloading caused by failure to properly conduct or dissipate optical power generated by the transmitter 102, leading to improper dissipation of the optical power. Contamination, misalignment or a break in the optical cable 106 may lead to substantial dissipation losses and resulting overheating of the optical cable 106 and can cause possibly serious damage, to the transmitter 102 or the optical cable 106.

The transmitter monitor 112 includes a transmitter photosensor 210, optically connected to the second WDM 208. The transmitter photosensor 210 may suitably be an avalanche photodetector. The use of an avalanche photodetector provides a high level of sensitivity, useful for detecting what may be a very low level of reflected light.

The transmitter photosensor 210 senses the return signal and creates a photosignal, such as a photocurrent, in response to the return signal. The photosignal may suitably be provided as an input to an amplifier 212 to produce a transmitter monitor signal. The transmitter monitor signal is provided as an input to the transmitter control module 110. The transmitter control module 110 may suitably include a communication interface 214, processor 216, memory 218, power control circuit 220, or other suitable components to allow the transmitter control module 110 to receive and interpret of signals and take appropriate action based on the signals. The memory 218 may suitably include a comparison table 221, storing predetermined criteria against which to compare the transmitter monitor signal. The comparison table 221 may be programmed at installation of the transmitter 110, suitably by transmitting an appropriate programming signal that will be interpreted by the processor 216 to cause storage of the desired values. Alternatively, the transmitter 110 may be designed so that the comparison table 221 may be programmed remotely at any time. The transmitter control module 110 may suitably use the processor 216 to compare the transmitter monitor signal against the predetermined criteria to determine whether the transmitter monitor signal indicates detection of reflected light levels, changes, optical signals or other phenomena indicating undesirable conditions affecting the connection between the transmitter 102 and the receiver 104. The criteria against which the comparison is made may suitably be stored in the memory 218. The transmitter control module 110 may, for example, compare the transmitter monitor signal to predetermined criteria selected to determine whether the current is above or below a threshold level. Alternatively or additionally, the transmitter control module 110 may monitor the transmitter monitor signal for changes, storing samples of the signal in the memory 218 and examining the samples to identify changes.

For example, if the optical cable 106 becomes contaminated, the reflected transmitter signal coming into the transmitter monitor 112 may increase, because the contamination partially blocks the conduction of the transmitter signal through the optical cable 106 into the receiver 104 and causes increased reflection of the transmitter signal back into the transmitter 102. This increase in the reflected transmitter signal will cause an increase in the photosignal and thus in the transmitter monitor signal. The transmitter control module 110 may be designed or programmed to detect this increase and respond appropriately, for example by shutting down the pump module 111 and activating the alarm 114 of FIG. 1.

To take another example, if the optical cable 106 becomes disconnected, the return signal coming into the transmitter monitor 112 may substantially decrease or stop altogether. This decrease in or cessation of the reflected transmitter signal will cause a decrease in the photosignal and in the transmitter monitor signal. The transmitter control module 110 may be designed or programmed to detect this decrease and respond, for example by shutting down the pump module 111.

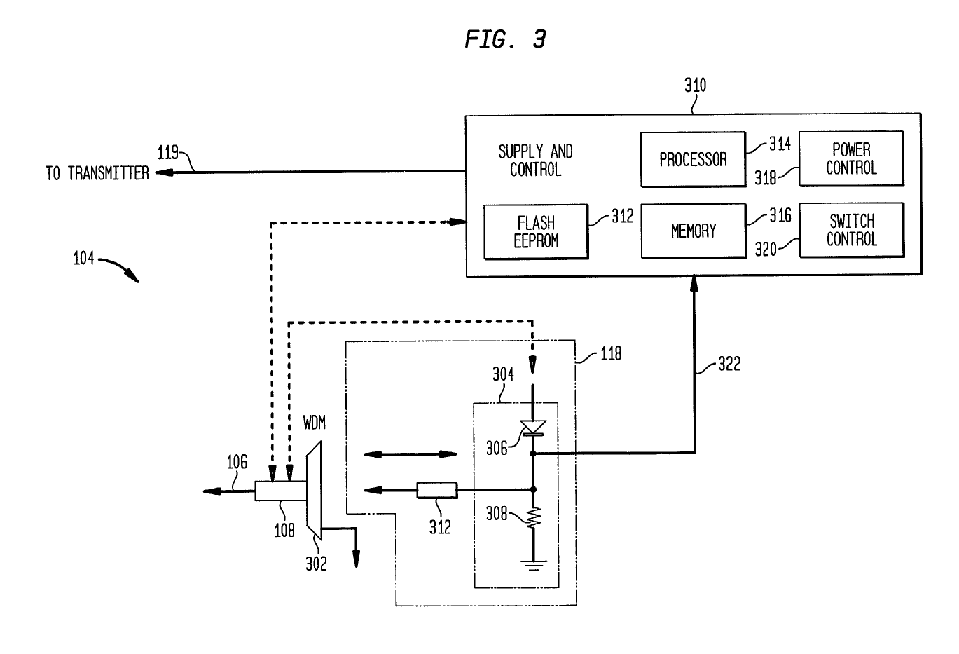

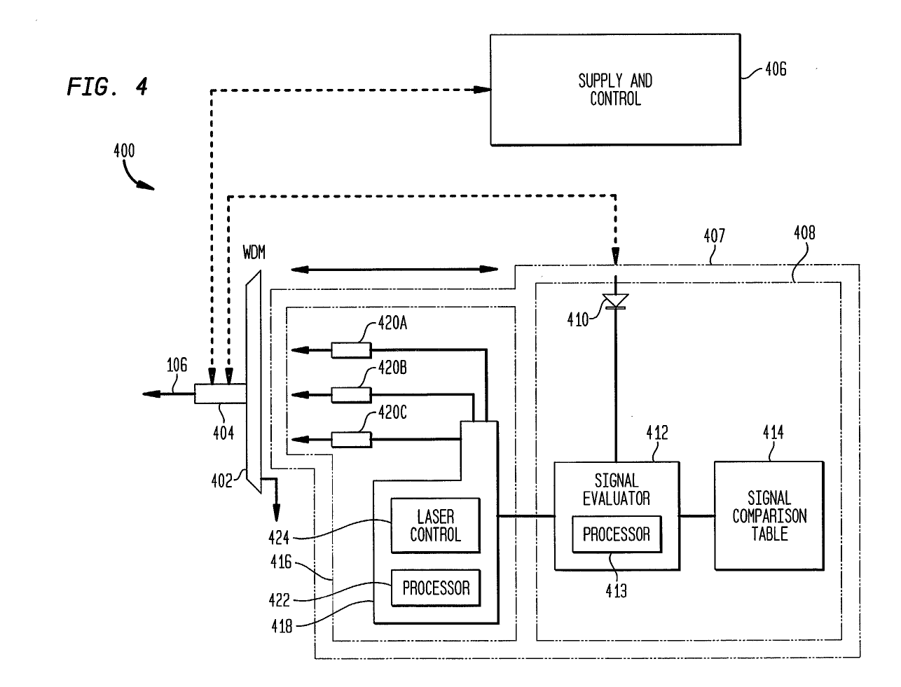

FIG. 3 illustrates additional details of the receiver 104. The receiver 104 comprises a WDM 302, which receives optical transmissions transmitted through the optical cable 106 by the transmitter 102. The receiver 104 includes the receiver connector 108, used to connect and disconnect the receiver 104 and the optical cable 106. The receiver 104 also includes the receiver monitor 118. The receiver monitor 118 includes a receiver photodetection module 304, which receives a portion of the transmitter signal that has entered the WDM 302 and creates one or more electrical or optical signals based on the characteristics of the transmitter signal that has been detected. The receiver photodetection module 304 typically receives less than 0.05% of the transmitter signal produced by the EDFA 206. In the exemplary embodiment shown here, the photodetection module 304 is shown as having a relatively simple design consisting of an optical transducer 306 and a load resistor 308. An exemplary alternative receiver design, employing a receiver monitor having a more complex design, is illustrated in FIG. 4 and discussed below.

The receiver monitor 118 is preferably connected to a supply and control module 310 capable of receiving signals from the receiver monitor 118 and performing control functions based on those signals. The supply and control module 310 can be programmed to perform specified actions upon receiving a particular signal from receiver monitor 118 and can also contain stored data for use by the receiver monitor 118. For example, the supply and control module 310 may contain a flash EEPROM 312 including values and instructions for use by the receiver monitor 118. The flash EEPROM 312 may contain expected values for the transmitter signal, limits within which the transmitter signal is expected to fall and threshold values for the transmitter signal, with the flash EEPROM 312 also including instructions for actions to be taken depending on the relation of the transmitter signal to the expected values and thresholds. The supply and control module may suitably include a processor 314 and memory 316, as well as a power control 318 and switch control 320.

The transducer 306 monitors the transmitter signal received from the WDM 302 and preferably produces electrical and optical signals based on the signal. In the exemplary embodiment shown here, electrical signals produced by the transducer 306 are passed out of the receiver monitor 118 for use in controlling the connection of the receiver 102 to the optical cable 106, or for use in controlling the transmitter 102. In the present relatively simple design for the receiver monitor 118, the electrical signals may suitably be proportional to the light received.

The receiver connector 108 may suitably be designed so that the optical transducer 306 is turned off when the receiver connector is disconnected, thereby stopping or altering signals transmitted by the receiver monitor 118 via the optical cable 106. In addition, the disconnection of the optical cable 106 from the receiver 118 changes the reflected light carried by the optical cable 106 to the transmitter 102. These changes may suitably be detected by the transmitter monitor 112. The transmitter monitor 112 will transmit signals indicating the changes to the transmitter control module 110, and the transmitter control module 110 will make appropriate adjustments to the operation of the transmitter 102, in accordance with predetermined programming.

In addition, the receiver monitor 118 may also provide an electrical signal to the supply and control module 310 using an electrical connection 312. The supply and control module may suitably interpret the electrical signal to determine whether or not the receiver is to be turned off or if the receiver connector 108 should be disconnected from the optical cable 106. In the exemplary embodiment shown here, an electrical connection exists between the receiver 104 and the transmitter 104. Because the connection 119 is present, the supply and control module 310 may suitably be programmed or designed to use the electrical connection 119 to communicate electrically with the transmitter control module 110 in order to control the transmitter 102.

Electrical communication between the receiver 104 and the transmitter 102 is not as fast as the speeds that can be achieved by optical communication. If the receiver monitor 118 detects conditions which may result in damage to the transmitter 102, receiver 104 or optical cable 106, the supply and control module 310 may be unable to signal the transmitter electrically before serious damage occurs. In addition, many or most transmitter-receiver pairs do not provide electrical connections between the transmitter and the receiver, because of the expense of providing an electrical connection in addition to the optical connector.

In order to allow the receiver 104 to communicate with the transmitter 102, the receiver monitor 118 is preferably capable of transmitting an optical signal to the transmitter 102 through the optical cable 106. The receiver monitor 118 therefore includes a receiver monitor signal generator 312, shown here as a laser. The receiver monitor signal generator 312 transmits light to be detected by the transmitter photosensor 210. Injection of light into the optical cable 106 by the signal generator 312 will cause the light to be conveyed to the transmitter 102. When the light enters the transmitter 102, it will cause the transmitter photosensor 210 to produce a photosignal that can be used to provide information to the transmitter control 110. For example, the receiver monitor signal generator 312 may be designed so that it will be active whenever the receiver monitor 118 detects a normal transmission. In such a case, the transmitter monitor 112 may be designed to shut off the transmitter 102 whenever the light from the receiver monitor signal generator 312 is not received. Alternatively, the receiver monitor signal generator 312 may be designed so as to transmit light into the WDM 302 whenever the receiver monitor 118 detects an abnormal transmission. In such a case, the transmitter monitor 112 may be designed to shut off the transmitter 102 whenever the light from the receiver monitor signal generator 312 is detected.

FIG. 4 illustrates an alternative receiver 400, showing a receiver monitor 402 having a more complex design than the receiver monitor 118. The receiver 400 includes a WDM 402 and a microswitch 404, similar to the WDM 302 and the microswitch 108 of FIG. 3, respectively. The receiver 400 also includes a supply and control module 406, similar to the supply and control module 310 of FIG. 3. The receiver 400 also includes a receiver monitor 407. The receiver monitor 407 includes a photodetection module 408. The photodetection module 408 comprises a transducer 410, which may suitably be similar to the transducer 306 of FIG. 3, and a signal evaluator 412. The transducer 410 produces signals in response to its detection of light received from the WDM 402. The signal evaluator 412 receives these signals and may include a processor 413 to compare the signals against predetermined criteria chosen to indicate when particular actions are to be taken based on the characteristics of the light detected from the WDM 402, and to create instructions determining which actions are to be taken. A set of predetermined criteria may suitably be stored in a signal comparison table 414, which may be programmed with possible characteristics of the signal produced by the transducer 410, along with actions to be taken if the signal has the specified characteristics. The signal comparison table 414 may be programmed at the time the receiver 104 is installed. Alternatively, the signal comparison table may be programmed remotely, for example by sending signals along the optical cable 106 which will cause the transducer 410 to generate a signal that will be interpreted by the processor 413 as a programming signal, including details of the values with which the signal comparison table 414 is to be programmed. Actions with which the signal comparison table may be programmed include, for example, directing the monitor and control unit 406 to shut down the receiver 104 and to disconnect the receiver connector 402. The signal evaluator 412 may also direct that an optical signal be sent to the transmitter 102, in order to stop or otherwise control the operation of the receiver.

The receiver monitor 400 includes an optical signal generator 416, in order to allow the receiver monitor 400 to transmit optical signals to the transmitter 102. The optical signal generator may receive instructions from the signal evaluator 412 and may transmit optical signals to the transmitter 102 in accordance with those instructions. By transmitting optical signals to the transmitter 102, the receiver monitor 400 can control the transmitter 102 by communicating with the transmitter monitor 112. The optical signal generator 416 includes an optical signal control module 418, and a selection of lasers 420A-420C. The optical signal control module 418 may suitably include a processor 422 for interpreting instructions received from the signal evaluator 412, and a laser control 424 for controlling the lasers 420A-420C in accordance with instructions from the processor 422. Each of the lasers 420A-420C may suitably be chosen to produce light having a desired wavelength and other characteristics, and the optical signal control module 418 selects the desired laser and operates it in order to send the desired signal to the transmitter 102. In the present example, the laser 420A is active when the light detected from the WDM 402 is within normal limits. The transmitter control module 110 belonging to the transmitter 102 of FIG. 1 may suitably be programmed so that if the return signal includes a transmitter monitor signal having the characteristics provided by the laser 420A, the transmitter control module 110 will interpret the presence of such a signal as indicating that the transmitter 102 is operating normally, and when a signal having these characteristics is no longer detected, the transmitter 102 should be shut off. The laser 420B is active when the light detected from the WDM 402 exceeds allowable limits. The supply and control module belonging to the transmitter 102 is programmed so that when the return signal includes a transmitter monitor signal having the characteristics provided by the laser 420B is detected, the transmitter 102 is shut off.

The signal evaluator 412 directs the operation of the optical signal control module 418 based on the signal received from the transducer 410 and the criteria stored in the signal comparison table 414. By comparing the signal from the transducer 410 against these criteria, the signal evaluator 412 is able to determine the condition of the light received from the transmitter 102 and to use the optical signal generator 416 to send information to the transmitter 102 based on the detected condition of the light received from the transmitter 102.

For example, the comparison table 414 may include a lower bound and an upper bound of the signal expected from the transducer 410, along with actions to be taken if the signal from the transducer 410 is below the lower bound, between the lower bound and the upper bound and above the upper bound. To take a specific example, the lower bound may be 0.5 mW. If the signal from the transducer 410 is below this value, it is an indication that the optical cable 106 is disconnected or broken, that the transmitter 102 should be shut off. If the signal is above 0.5 mW but below 1 mW, it is an indication that the signal being received from the transmitter 102 is normal. If the signal is above 1 mW, it is an indication that excessive power is being generated by the transmitter 102 and that the transmitter should be shut off.

Thus, when the signal from the transducer 410 is below 0.5 mW, the signal evaluator 412 directs the optical signal control module 418 to deactivate the laser 420A. As noted above, the laser 420A is active when a normal connection is detected. If the optical cable 106 is broken, the transmitter monitor 112 will detect the loss of the light from the laser 420A, but deactivating the laser 420A will provide additional assurance that the signal will not be detected, in case the problem is something other than a break in the connector 106. When the signal from the transducer 410 is between 0.5 mW and 1.0 mW, the signal evaluator directs the optical signal control module 418 to keep the laser 420A active. When the signal from the transducer 418 is greater than 0.1 mW, the signal evaluator 412 directs the optical signal control module 418 to deactivate the laser 420A and to activate the laser 420B. This action removes the signal produced by the laser 420A and interpreted by the transmitter control module 110 to indicate that the transmitter 102 is operating normally, and sends a signal interpreted by the transmitter control module 110 as giving an active indication that the transmitter 102 should be shut off.

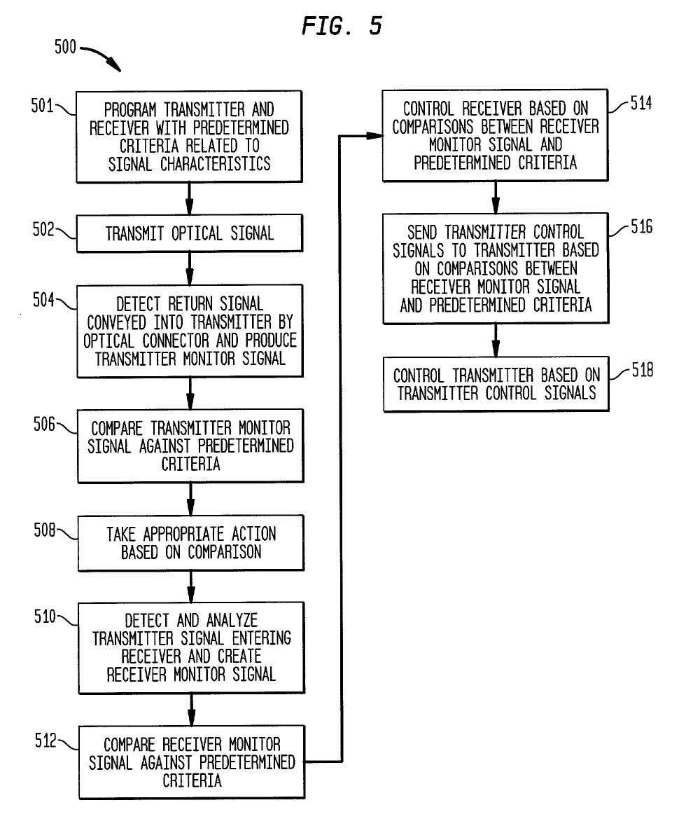

FIG. 5 illustrates a process 500 of transmitter and receiver control and communication according to the present invention. At step 501, a transmitter and receiver of a transmitter-receiver pair, communicating through optical signals conducted along an optical cable, are programmed with predetermined criteria indicating expected values, limits, and thresholds of optical signals conducted between the transmitter and the receiver by the optical cable, and actions to be taken based on comparison of optical signal characteristics with the predetermined criteria. Programming may be done at initial installation of the transmitter and receiver, and may be repeated when needed in order to update the predetermined criteria. The transmitter may suitably be similar to the transmitter 102 of FIGS. 1 and 2, and the receiver may suitably be similar to the receiver 104 of FIGS. 1-3, or the receiver 400 of FIG. 4. The optical cable may suitably be similar to the optical cable 106 of FIGS. 1-4. The optical signals may suitably be laser amplified optical signals such as are typically used to convey information over a fiber optic connection. At step 502, an optical signal is transmitted from the transmitter to the receiver, using the optical cable. At step 504, optical signals being conveyed into the transmitter by the optical cable are monitored and a transmitter monitor signal is produced based on the optical signals. The monitoring and the production of the transmitter monitor signal may be performed by a transmitter monitor similar to the transmitter monitor 112 of FIG. 1. At step 506, the transmitter monitor signal is compared against the predetermined criteria programmed into the transmitter. At step 508, appropriate actions are taken based on the comparison of the transmitter monitor signal with the predetermined characteristics. Comparison of the transmitter monitor signal with the predetermined characteristics may indicate changes in the level of reflection losses, the interruption of the optical signal or the like. Actions taken may be isolation of the transmitter from the optical cable, shutting down the transmitter or adjustment of the transmitter. Other suitable actions may be sounding of an alarm or other notification of an attendant.

At step 510, the transmitter signal entering the receiver is detected and used to create a receiver monitor signal based on characteristics of the optical signal. At step 512, the receiver monitor signal is compared to predetermined criteria programmed into the receiver. At step 514, appropriate actions are taken to control the receiver based on the comparisons between the receiver monitor signal and the predetermined criteria. Actions may include shutoff of the receiver or disconnection of the receiver from the optical cable. At step 516, transmitter control signals are sent to the transmitter based on the comparisons between the receiver monitor signal and the predetermined criteria. For example, a transmitter control signal indicating a normal connection may continued or depending on whether the receiver monitor signal falls within the criteria indicating a normal condition. As another example, a transmitter control signal commanding shutdown of the transmitter may be sent if the receiver monitor signal indicates excessive dissipation losses in the optical cable. At step 518, the transmitter control signals sent from the receiver to the transmitter are detected and used to make appropriate adjustments to the operation of the transmitter. The optical signals sent from the receiver to the transmitter cause the generation of transmitter monitor signals which control the operation of the transmitter based on the comparisons of the transmitter monitor signals against the predeterminded criteria.

While the present invention is disclosed in the context of a presently preferred emobodiment, it will be recognized that a wide variety of implementations may be employed by person of ordinary skill in the art consistent with the above discussion and the claims which follow below.

We claim:

1. An optical monitor for monitoring an optical signal from a transmitter, comprising:
a sensor for sensing the dissipation of optical power of the optical signal and for producing a sensing signal corresponding with the sensed dissipation; and
a control system for adjusting the optical transmitter in response to the sensing signal.

2. The optical monitor of claim 1, wherein the control system interprets the sensing signal in order to determine whether the sensing signal indicates improper dissipation of optical power and, if so, adjusts the optical transmitter in order to correct such improper dissipation of optical power.

3. The optical monitor of claim 2, wherein the control system interprets the sensing signal to determine if the optical power dissipation is outside predetermined limits and adjusts the transmitter if the optical power dissipation is outside the predetermined limits.

4. The optical monitor of claim 3, wherein the control system adjusts the transmitter to bring the optical power dissipation within the predetermined limits if the optical power dissipation is outside the predetermined limits.

5. The optical monitor of claim 4, wherein the control system stops operation of the transmitter if the optical power dissipation is outside the predetermined limits.

6. The optical monitor of claim 5, wherein the sensor senses the dissipation of optical power of the optical signal by sensing a return signal conducted into the transmitter.

7. The optical monitor of claim 6, wherein the sensor senses reflection losses present in the return signal, the reflection losses indicating the optical power dissipated by the optical signal.

8. The optical monitor of claim 7, wherein the sensor senses a component of the return signal contributed by a receiver receiving the optical signal and indicating optical power dissipation of the optical signal detected at the receiver.

9. The optical monitor of claim 8, wherein the sensor is an avalanche photodetector.

10. A receiver monitor for monitoring an optical signal received from an optical transmitter, comprising:
a receiver sensor for sensing the dissipation of optical power of the optical signal and producing a receiver sensing signal based on the sensed dissipation; and
a transmitter signaling device for transmitting an optical control signal to a transmitter producing the optical signal, the optical control signal being based on the receiver sensing signal and indicating whether the sensing signal indicates an improper dissipation of optical power.

11. The receiver monitor of claim 10, wherein the transmitter signaling device comprises a transmitter signaling controller and one or more light sources, the transmitter signaling controller being operative to select and operate a selected one of the light sources to transmit an appropriate optical control signal to the transmitter.

12. The receiver monitor of claim 11, wherein the transmitter signaling device is operative to send a normal operation signal to the transmitter when the receiver sensing signal indicates that the optical power dissipation of the optical signal falls within normal limits and wherein the transmitter signaling device is operative to stop sending the normal operation signal whenever the receiver sensing signal indicates that the optical power dissipation of the optical signal falls outside normal limits.

13. A method of optical transmitter control, comprising the steps of:
sensing the dissipation of optical power of an optical signal; and
controlling the transmitter based on the sensed dissipation.

14. The method of claim 13, wherein the step of adjusting the transmitter based on the sensed dissipation includes interpreting the sensing signal to determine whether the sensed dissipation falls outside normal limits and shutting off the transmitter if the sensed dissipation falls outside normal limits.

15. The method of claim 14, wherein sensing the dissipation of optical power of the optical signal includes sensing a return signal conducted into the transmitter from an optical cable.

16. The method of claim 15, wherein the return signal includes a component comprising reflections of the optical signal back into the transmitter along the optical cable and wherein an excessive level of reflection is interpreted as indicating improper dissipation of optical power.

17. The method of claim 16, further comprising the steps of:
sensing the optical power dissipation of the optical signal at an optical receiver;
transmitting a control signal to the transmitter to adjust the transmitter based on the sensed dissipation at the receiver.

18. The method of claim 17, wherein the control signal includes a component indicating normal operation when the receiver sensing signal indicates that the optical power dissipation of the optical signal is within normal limits.

19. The method of claim 18, wherein the control signal does not include a component indicating normal operation when the receiver sensing signal indicates that the optical power dissipation of the optical signal falls outside normal limits.

20. The method of claim 20, wherein the control signal includes a component indicating abnormal operation when the receiver sensing signal indicates that the optical power dissipation of the optical signal falls outside normal limits.
